(19) United States
(12) Patent Application Publication
(10) Pub. No.: US 2016/0078543 A1
(43) Pub. Date: Mar. 17, 2016

(54) MODELING EXPENSES BASED ON DEMOGRAPHICS AND OCCURRENCE OF EVENTS

(71) Applicant: ADP, LLC, Roseland, NJ (US)

(72) Inventor: Benjamin J. DZIUBA, New York, NY (US)

(21) Appl. No.: 14/483,845

(22) Filed: Sep. 11, 2014

(51) Int. Cl. G06Q 40/08; G06Q 10/06

(52) U.S. Cl. CPC G06Q 40/08; G06Q 10/067

(57) ABSTRACT

Systems and methods of modeling expenses based on demographic information are disclosed. The method of modeling medical insurance expenses is implemented by a computer system. The method includes determining an initial estimate of a contribution cost to a consumer for a plurality of offered medical insurance plans based on demographic information associated with the consumer. The method further includes launching the consumer to an estimator tool which displays values associated with different scenarios initially based on the demographic information. The method further includes recalculating the initial estimate of the contribution cost of the plurality of offered medical insurance plans based on adjusted values of one or more of the different scenarios, as adjusted by the consumer. The method further includes displaying, as an updated estimate contribution cost, the recalculated initial estimate of the contribution cost to the consumer for each of the offered medical insurance plans.

### TECHNICAL FIELD

The invention relates to systems and methods of modeling expenses and, more particularly, to systems and methods of modeling expenses based on demographic information.

### BACKGROUND

The cost of health care services and the many variables affecting the cost of health care services are important factors in selecting certain medical insurance plans. That is, costs can have a major impact on the decision to purchase certain types of medical insurance plans, from basic medical insurance coverage to coverage with a host of more advanced options. In fact, in many instances consumer costs are a driving factor in selecting certain medical insurance plans.

Typically, an employer offers several medical insurance plans to their employees. These medical insurance plans come with different costs and different coverage. For example, one medical insurance plan can have a high deductible with a low premium; whereas, another medical insurance plan may have a low deductible with a high premium. These different plans can also include different co-payments and costs for different prescription drug plans. To complicate the selection process even more, the employer can offer certain benefits to their employees, ranging from health savings accounts (HSA) to premium support. With these many factors to consider, it becomes ever more difficult for a consumer to select an appropriate medical insurance plan.

### SUMMARY OF THE INVENTION

In a first aspect of the invention, a method of modeling medical insurance expenses implemented by a computer system comprises determining an initial estimate of a contribution cost to a consumer for a plurality of offered medical insurance plans based on demographic information associated with the consumer. The method further comprises launching the consumer to an estimator tool which displays values associated with different scenarios initially based on the demographic information. The method further comprises recalculating the initial estimate of the contribution cost of the plurality of offered medical insurance plans based on adjusted values of one or more of the different scenarios, as adjusted by the consumer. The method further comprises displaying, as an updated estimate contribution cost, the recalculated initial estimate of the contribution cost to the consumer for each of the offered medical insurance plans.

In a further aspect of the invention, a computer system for generating estimate contribution costs for medical insurance comprises: a hardware memory device that stores program instructions and demographic and associated cost information associated with a plurality of medical insurance plans; and a processor that executes the program instructions and causes the computer system to: estimate a minimum contribution cost, typical contribution cost and maximum contribution cost for a plurality of offered medical insurance plans based on the demographic information associated with the consumer; recalculate the typical contribution cost of the plurality of offered medical insurance plans based on adjusted values of one or more of different plan options for each of the plurality of offered medical insurance plans; and automatically display, as an updated estimate contribution cost, the typical contribution cost to the consumer for each of the offered medical insurance plans.

In a further aspect of the invention, a computer program product comprises computer readable program instructions stored on non-transitory computer readable storage medium. The computer readable program instructions causing a computing device to: estimate a minimum contribution cost, typical contribution cost and maximum contribution cost for a plurality of offered medical insurance plans based on the demographic information associated with the consumer; display the minimum contribution cost, typical contribution cost and maximum contribution cost for the plurality of offered medical insurance plans; calculate and display a per pay check cost for the minimum contribution cost for the plurality of offered medical insurance plans; recalculate the typical contribution cost of the plurality of offered medical insurance plans based on adjusted values of one or more of different plan options for each of the plurality of offered medical insurance plans; and automatically updated the typical contribution cost, while keeping the minimum contribution cost and the maximum contribution cost static.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 is an illustrative architecture of a computing system implemented as embodiments of the present invention.

FIG. 2 shows an exemplary cloud computing environment in accordance with aspects of the invention.

FIGS. 3-8 show exemplary user interfaces and underlying in accordance with aspects of the invention.

FIG. 9 depicts an exemplary flow for a process in accordance with aspects of the present invention.

### DETAILED DESCRIPTION OF ASPECTS OF THE INVENTION

The invention relates to systems and methods of modeling expenses and, more particularly, to systems and methods of modeling expenses based on demographic information. More specifically, the present invention relates to systems and methods of modeling medical expenses and more particularly estimating consumer costs based on demographic information. In embodiments, the consumer can fine tune or adjust the cost estimate by adjusting values of different scenarios associated with the medical insurance plans (and/or demographic information). In this way, the systems and methods of the present invention allow a consumer to compare out-of-pocket contribution costs of medical insurance for different medical insurance plans using different scenarios, based on the demographic information and as adjusted by the user (consumer) according to different unique situations or scenarios.

In accordance with embodiments of the present invention, the systems and methods (e.g., cost comparison tool) allow a user to select possible future events in order to calculate more accurately estimate medical expenses associated with unique situations under various aspects of multiple medical plans. For example, by implementing the cost comparison tool the user can edit medical usage levels based on an individual situation and, based on such adjusted information, obtain cost estimates for particular medical insurance plans. In this way, the consumer is provided an opportunity to make an educated decision with regard to comparison costs of different medical insurance plans based on unique situations relevant to the requesting consumer and, hence select appropriate medical insurance coverage.

In embodiments, the cost comparison tool provides a model of consumer contribution costs based on demographic information obtained from, for example, a third party service provider. This demographic information can then be used to model individual costs for different medical insurance plans based on individual scenarios, and using these estimate costs (amongst other features) make a comparison for selection of the most appropriate medical insurance plan. The modeled medical costs include costs directly attributable to an employee and, depending on benefits received from an employer, can include all out-of-pocket expenses, taking into consideration factors such as health savings accounts (HSA), particular usage of certain services, etc.

By way of an illustrative example, the demographic information used to provide cost estimates of different medical plans can include economic status, age, health (past medical history), family and/or marital status, location, medical service usage (e.g., use of medical services (e.g., doctor visits, hospital stays, x-rays and other diagnostics), prescription usage, etc. In embodiments, the demographic information can be obtained from statistical information collated, developed, and/or created, etc. by a third party service provider, as further described herein.

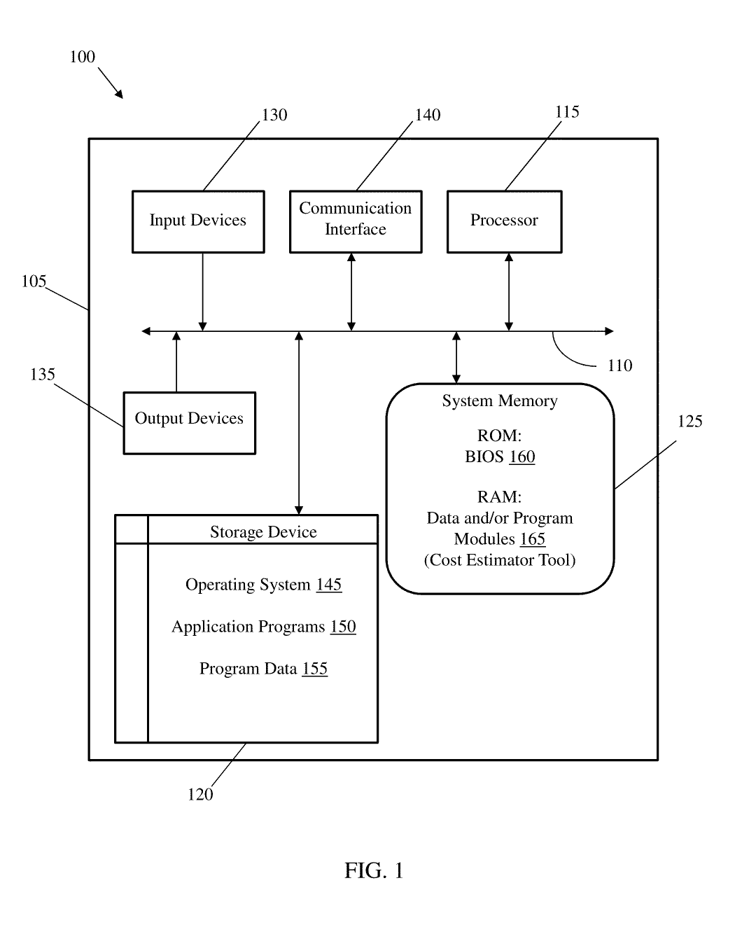

FIG. 1 is an illustrative architecture of a computing system 100 implemented as embodiments of the present invention. The computing system 100 is only one example of a suitable computing system and is not intended to suggest any limitation as to the scope of use or functionality of the invention. Also, computing system 100 should not be interpreted as having any dependency or requirement relating to any one or combination of components illustrated in computing system 100.

As shown in FIG. 1, computing system 100 includes a computing device 105. The computing device 105 can be resident on a network infrastructure such as within a cloud environment, or may be a separate independent computing device (e.g., a computing device of a third party service provider). The computing device 105 may include a bus 110, a processor 115, a storage device 120, a system memory (hardware device) 125, one or more input devices 130, one or more output devices 135, and a communication interface 140.

The bus 110 permits communication among the components of computing device 105. For example, bus 110 may be any of several types of bus structures including a memory bus or memory controller, a peripheral bus, and a local bus using any of a variety of bus architectures to provide one or more wired or wireless communication links or paths for transferring data and/or power to, from, or between various other components of computing device 105.

The processor 115 may be one or more conventional processors, microprocessors, or specialized dedicated processors that include processing circuitry operative to interpret and execute computer readable program instructions, such as program instructions for controlling the operation and performance of one or more of the various other components of computing device 105 for implementing the functionality, steps, and/or performance of the present invention.

In embodiments, processor 115 interprets and executes the processes, steps, functions, and/or operations of the present invention, which may be operatively implemented by the computer readable program instructions. For example, processor 115 can calculate contribution cost estimates for medical insurance plans based on, for example, demographic information. In embodiments, the demographic information can be stored in the storage device 120, and can include a host of disparate information that is not typically collated in any single database. This disparate information can be, e.g.,
(i) economic status;
(ii) age;
(iii) health (e.g., past medical history);
(iv) family and/or marital status;
(v) residency of the individual requesting a cost estimate;
(vi) employee offered plans;
(vii) medical service usage (e.g., use of medical services (e.g., doctor visits, hospital stays, x-rays, and other diagnostics testing, surgeries, etc.); and/or
(viii) prescription usage (e.g., brand name and generic prescriptions, etc.), etc.

This demographic information is used to calculate initial cost estimates for different medical insurance plans offered, e.g., by an employer. In embodiments, the storage system contains medical expenses for different events based on average expenses for a particular group, e.g., cost per service, number of uses for a given event, etc. These costs can be applied to different medical plans for comparison, with the events being customized based on likelihood of certain events for the user's demographics or personal situation, or past medical history. In aspects of the present invention, the demographic information can be obtained from disparate databases which include the different types of information needed to provide cost estimate information for different medical plans. This information can then be used to estimate contribution costs for different insurance plans using, e.g., statistical information known to those in the insurance industry. For example, the estimate contribution costs can be based on different models using the demographic information. These models include, e.g., risk-adjustment models, deterministic models, payer-centric data, etc. By way of more specific example, the risk-adjustment model can use the demographic infor nation to estimate an expected annual cost for each consumer to be enrolled in a medical insurance plan. In this way, the present invention contemplates that a service provider has access to different information in order to obtain, collate, develop, and/or create the necessary statistical information to be used by the cost estimator tool of the present invention. This demographic information can then be used to provide an added service to employees.

Also, additional information can be provided by the consumer to recalculate out-of pocket expenses for the consumer, in order to determine a more accurate cost estimate, and hence allow the consumer to make an educated selection decision for different medical plans and different individual situations. For example, the cost estimator tool of the present invention provides the consumer the ability to adjust services associated which, in turn, will adjust contribution costs for the consumer. This will allow the consumer to compare medical costs for different scenarios. This adjusted information can include, for example, amongst other things:
(i) number of anticipated visits to a doctor's office;
(ii) anticipated surgeries, e.g., number and type;
(iii) number of x-rays and other diagnostics testing; and/or
(iv) different brand and generic prescriptions.

In aspects of the present invention, the cost estimator tool has access to costs associated with different medical plans in order to make adjustments for out-of-pocket expenses based on the different scenarios provided by the consumer. The different types of expenses can include, for example, any deductibles as well as copayments for doctor's visits, prescription drugs, diagnostic testing, etc. In embodiments, these different types of expenses are provided in the storage device 120, associated with the appropriate medical insurance plan. This information can then be used to fine tune the contribution costs for different insurance plans using different scenarios that are unique to the consumer. In this way, the present invention contemplates that a service provider has access to different information of each medical insurance plan offered, e.g., by an employer.

In embodiments, processor 115 may receive input signals from one or more input devices 130 and/or drive output signals through one or more output devices 135. The input devices 130 may be, for example, a keyboard or touch sensitive user interface (UI) as further described below. The output devices 135 can be, for example, any display device, printer, etc., as further described below.

The storage device 120 may include removable/non-removable, volatile/non-volatile computer readable media, such as, but not limited to, non-transitory media such as magnetic and/or optical recording media and their corresponding drives. The drives and their associated computer readable media provide for storage of computer readable program instructions, data structures, program modules and other data for operation of computing device 105 in accordance with the different aspects of the present invention. In embodiments, storage device 120 may store operating system 145, application programs 150, and program data 155 in accordance with aspects of the present invention.

The system memory 125 may include one or more storage mediums, including for example, non-transitory media such as flash memory, permanent memory such as read-only memory (“ROM”), semi-permanent memory such as random access memory (“RAM”), any other suitable type of storage component, or any combination thereof. In some embodiments, an input/output system 160 (BIOS) including the basic routines that help to transfer information between the various other components of computing device 105, such as during start-up, may be stored in the ROM. Additionally, data and/or program modules 165, such as at least a portion of operating system 145, program modules application programs 150, and/or program data 155, that are accessible to and/or presently being operated on by processor 115, may be contained in the RAM. In embodiments, the program modules 165 and/or application programs 150 can comprise the cost estimation tool of the present invention, which provides the instructions for execution of processor 115.

The one or more input devices 130 may include one or more mechanisms that permit an operator to input information to computing device 105, such as, but not limited to, a touch pad, dial, click wheel, scroll wheel, touch screen, one or more buttons (e.g., a keyboard), mouse, game controller, track ball, microphone, camera, proximity sensor, light detector, motion sensors, biometric sensor, and combinations thereof. The one or more output devices 135 may include one or more mechanisms that output information to an operator, such as, but not limited to, audio speakers, headphones, audio line-outs, visual displays, antennas, infrared ports, tactile feedback, printers, or combinations thereof.

The communication interface 140 may include any transceiver-like mechanism (e.g., a network interface, a network adapter, a modem, or combinations thereof) that enables computing device 105 to communicate with remote devices or systems, such as a mobile device or other computing devices such as, for example, a server in a networked environment, e.g., cloud environment. For example, computing device 105 may be connected to remote devices or systems via one or more local area networks (LAN) and/or one or more wide area networks (WAN) using communication interface 140.

As discussed herein, computing system 100 may be configured to provide cost estimates and comparisons of different medical insurance based on demographic information and unique information provided by the consumer. In particular, computing device 105 may perform tasks (e.g., process, steps, methods and/or functionality) in response to processor 115 executing program instructions contained in computer readable medium, such as system memory 125. The program instructions may be read into system memory 125 from another computer readable medium, such as data storage device 120, or from another device via the communication interface 140 or server within or outside of a cloud environment. In embodiments, an operator may interact with computing device 105 via the one or more input devices 130 and/or the one or more output devices 135 to facilitate performance of the tasks and/or realize the end results of such tasks in accordance with aspects of the present invention. In additional or alternative embodiments, hardwired circuitry may be used in place of or in combination with the program instructions to implement the tasks, e.g., steps, methods and/or functionality, consistent with the different aspects of the present invention. Thus, the steps, methods and/or functionality disclosed herein can be implemented in any combination of hardware circuitry and software.

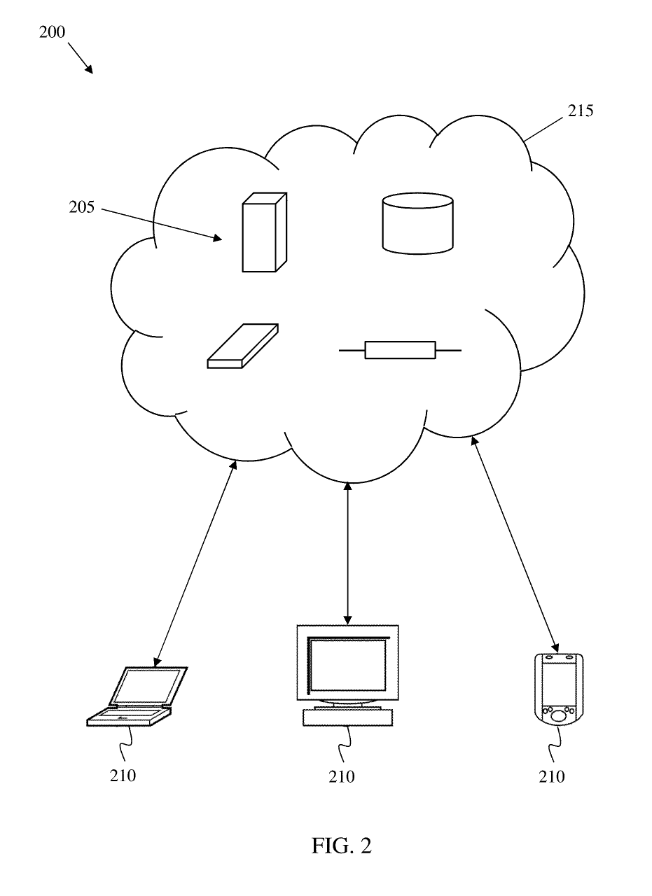

FIG. 2 shows an exemplary cloud computing environment 200. Cloud computing is a computing model that enables convenient, on-demand network access to a shared pool of configurable computing resources, e.g., networks, servers, processing, storage, applications, and services, that can be provisioned and released rapidly, dynamically, and with minimal management efforts and/or interaction with the service provider. In embodiments, one or more aspects, functions and/or processes described herein may be performed and/or provided via cloud computing environment 200.

As depicted in FIG. 2, cloud computing environment 200 includes cloud resources 205 that are made available to client devices 210 via a network 215, such as the Internet. Cloud resources 205 can include a variety of hardware and/or software computing resources, such as servers, databases, storage, networks, applications, and platforms. Cloud resources 205 may be on a single network or a distributed network. Cloud resources 205 may be distributed across multiple cloud computing systems and/or individual network enabled computing devices. Client devices 210 may comprise any suitable type of network-enabled computing device, such as servers, desktop computers, laptop computers, handheld computers (e.g., smartphones, tablet computers), set top boxes, and network-enabled hard drives. In embodiments, client devices 210 can be, for example, a desktop computer, laptop computer or mobile device of an employee. In alternative embodiments, the client devices 210 can be a computing system provided by an employee, which is accessible by an employee; although cloud resources 205 are typically provided and maintained by a service provider so that a client does not need to maintain resources on a local client device 210. In embodiments, cloud resources 205 may includes one or more computing system 100 of FIG. 1 that is specifically adapted to perform one or more of the functions and/or processes described herein.

Cloud computing environment 200 may be configured such that cloud resources 205 provide computing resources to client devices 210 through a variety of service models, such as Software as a Service (SaaS), Platforms as a service (PaaS), Infrastructure as a Service (IaaS), and/or any other cloud service models. Cloud resources 205 may be configured, in some cases, to provide multiple service models to a client device 210. For example, cloud resources 205 can provide both SaaS and IaaS to a client device 210. Cloud resources 205 may be configured, in some cases, to provide different service models to different client devices 210. For example, cloud resources 205 can provide SaaS to a first client device 210 and PaaS to a second client device 210.

Cloud computing environment 200 may be configured such that cloud resources 205 provide computing resources to client devices 210 through a variety of deployment models, such as public, private, community, hybrid, and/or any other cloud deployment model. Cloud resources 205 may be configured, in some cases, to support multiple deployment models. For example, cloud resources 205 can provide one set of computing resources through a public deployment model and another set of computing resources through a private deployment model.

One or more cloud resources 205 may be conceptually structured in multiple layers. In one example, the layers include a firmware and hardware layer, a kernel layer, an infrastructure service layer, a platform service layer, and an application service layer. The firmware and hardware layer may be the lowest layer upon which the other layers are built, and may include generic contributing nodes (e.g., data centers, computers, and storage devices) geographically distributed across the Internet and provide the physical resources for implementing the upper layers of the cloud service provider. The kernel layer is above the firmware and hardware layer and may include an operating system and/or virtual machine manager that host the cloud infrastructure services. The kernel layer controls and communicates with the underlying firmware and hardware layer through one or more hardware/firmware-level application programming interfaces (APIs). The infrastructure service layer is above the kernel layer and may include virtualized resources, such as virtual machines, virtual storage (e.g., virtual disks), virtual network appliances (e.g., firewalls), and so on. The infrastructure service layer may also include virtualized services, such as database services, networking services, file system services, web hosting services, load balancing services, message queue services, map services, e-mail services, and so on. The platform service layer is above the infrastructure service layer and may include platforms and application frameworks that provide platform services, such as an environment for running virtual machines or a framework for developing and launching a particular type of software application. The application service layer is above the platform service layer and may include a software application installed on one or more virtual machines or deployed in an application framework in the platform service layer. The software application can also communicate with one or more infrastructure service components (e.g., firewalls, databases, web servers, etc.) in the infrastructure service layer.

In another example, one or more cloud resources 205 may be conceptually structured in functional abstraction layers including hardware and software layers, a virtualization layer, a management layer, and a workloads layer. The hardware and software layer may include hardware and software components such as mainframes, RISC (reduced instruction set computer) architecture based servers, storage devices, networks and networking components, application server software, and database software. The virtualization layer may include virtual entities such as virtual servers, virtual storage, virtual networks, virtual applications, and virtual clients. The management layer may provide functions such as resource provisioning, metering and pricing, security, user portals, service level management, and service level agreement planning and fulfillment. The workloads layer may provide functions for which the cloud computing environment is utilized, such as mapping and navigation, software development and lifecycle management, data analytics and processing, and transaction processing.

In embodiments, software and/or hardware that performs one or more of the aspects, functions and/or processes described herein may be accessed and/or utilized by a client (e.g., an enterprise or an end user) as one or more of an SaaS, PaaS and IaaS model in one or more of a private, community, public, and hybrid cloud. Moreover, although this disclosure includes a description of cloud computing, the systems and methods described herein are not limited to cloud computing and instead can be implemented on any suitable computing environment.

Cloud resources 205 may be configured to provide a variety of functionality that involves user interaction. Accordingly, a user interface (UI) can be provided for communicating with cloud resources 205 and/or performing tasks associated with cloud resources 205. The UI can be accessed via the client device 210 in communication with cloud resources 205. The UI can be configured to operate in a variety of client modes, including a fat client mode, a thin client mode, or a hybrid client mode, depending on the storage and processing capabilities of cloud resources 205 and/or client device 210. Therefore, a UI can be implemented as a standalone application operating at the client device 210 in some embodiments. In other embodiments, a web browser-based portal can be used to provide the UI. Any other configuration to access cloud resources 205 can also be used in various implementations.

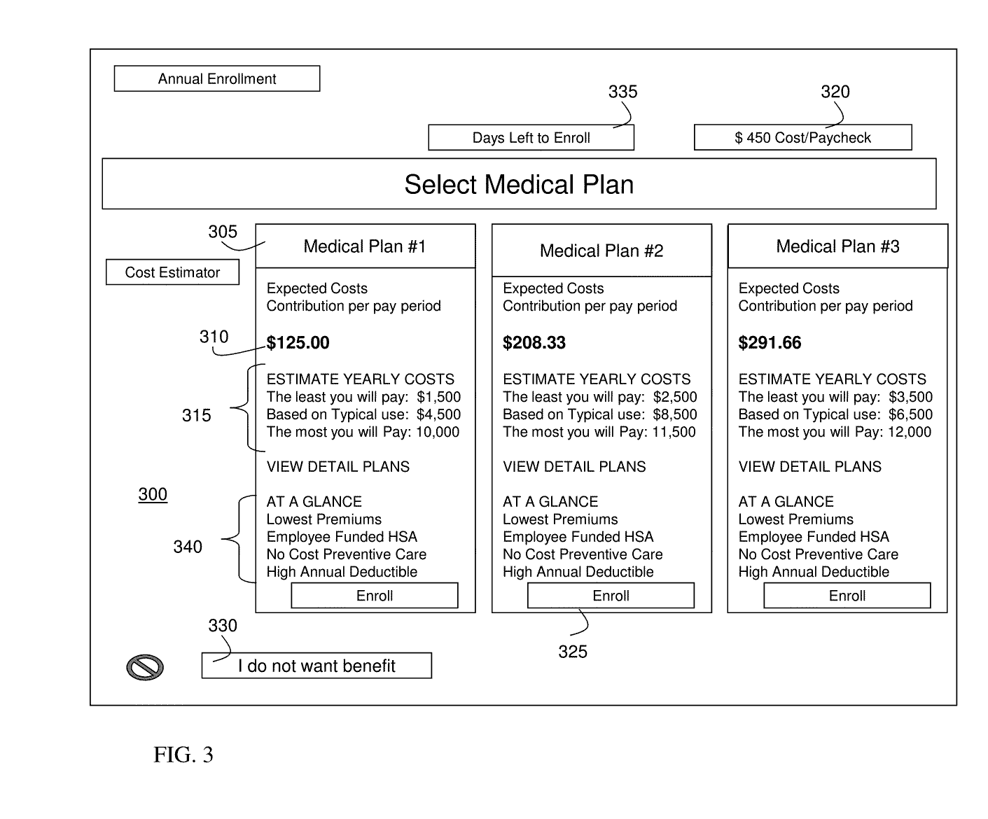

FIGS. 3-8 show various user interfaces (UI) representative and illustrative of functionality in accordance with aspects of the present invention. The various user interfaces (UI) can be provided on the client devices 210 via network 215, as described in FIG. 2. In addition, the underlying functionality shown in the various user interfaces (UI) can be provided by the computing system 100 of FIG. 1, as described herein. For example, any of the underlying calculations, adjustments and interfaces can be provided by computing system 100 of FIG. 1.

Specifically, FIG. 3 shows a cost comparison interface 300. From this interface, a user (e.g., consumer, employee, etc.) can compare different medical plans, based on expected costs, as well as begin exploring different medical plans based on different scenarios. In the example of FIG. 3, three different medical insurance plans and associated base contribution costs are shown as starting points, based on demographic information as described herein. These plans include medical plan #1, medical plan #2 and medical plan #3, represented at reference numeral 305. In embodiments, each of these medical plans 305 can be offered by an employer to an employee by way of an example. It should be understood by those of skill in the art that although three medical plans are shown in interface 300, any number of medical plans and associated costs, depending on factors such as employer approved plans, etc., are contemplated by the present invention.

As shown further in FIG. 3, for each of the different medical plans 305, an expected contribution per paycheck is shown at reference numeral 310. The expected contribution per paycheck 310 is based on a total yearly cost of the medical insurance (least amount of employer contribution) divided by the number of paychecks the consumer may receive in any given year. So, for the example of medical plan #1, an employee receiving 12 paychecks per year would have an estimated contribution per paycheck in the amount of $375, based on a least amount paid of $1,500 as shown at reference numeral 315. Of course, it should be understood by those of skill in the art that the contribution per paycheck can vary depending on the number of paychecks per year, the typical usage, as well as other factors such as individual usage scenarios and benefits received from the employer. For example, if the employee receives benefits in the amount of $500 per year from an employee, an appropriate adjustment will be made to both the least amount paid and the contribution per pay check.

Still referring to FIG. 3, the cost comparison interface 300 also includes a total estimated yearly cost of the medical plan. In embodiments, the estimated yearly cost is based different factors, including demographic information. These different costs can be, e.g., least amount of usage, typical amount usage and most amount of usage, shown generally at reference numeral 315. The typical amount of usage can be adjusted based on user provided information which, in turn, will automatically update the expected cost for contribution per pay period at reference numeral 310, as described further herein. The cost comparison interface 300 further provides the total amount of benefits per consumer's paycheck, as shown at reference numeral 320. These benefits can include, for example, life insurance benefits, dental benefits, HSA accounts, etc. And, by enrolling in a medical plan, these benefits can automatically update accordingly.

To assist in the enrollment process, the cost comparison interface 300 also provides the user with the ability to enroll in any desired medical plan, e.g., medical plan #1, medical plan #2 or medical plan #3, by simply selecting the enrollment “button” 325. On the other hand, the user can deny coverage by simply selecting the “I do not want benefit” button 330. It should be understood by those of skill in the art that the nomenclature used for any of the buttons, icons or descriptive terms herein is provided as an illustrative example, and that other descriptive terms, icons, and/or scroll down windows are contemplated by the present invention.

The cost comparison interface 300 also provides additional information about the particular medical plans including, for example, the days left for enrollment icon 335, as well as additional information “at a glance” shown at reference numeral 340. The days left for enrollment can be based on the open enrollment period and, more specifically, the number of days left in the open enrollment period. By selecting the days left for enrollment icon 335, a calendar with the last day of open enrollment for a particular medical plan can be displayed to the consumer, as an example. The “information at a glance” field 340 can include different medical plans based on such factors as, e.g., lowest premiums, employee funded health savings accounts (HSA), no cost preventative care, high annual deductibles, etc.

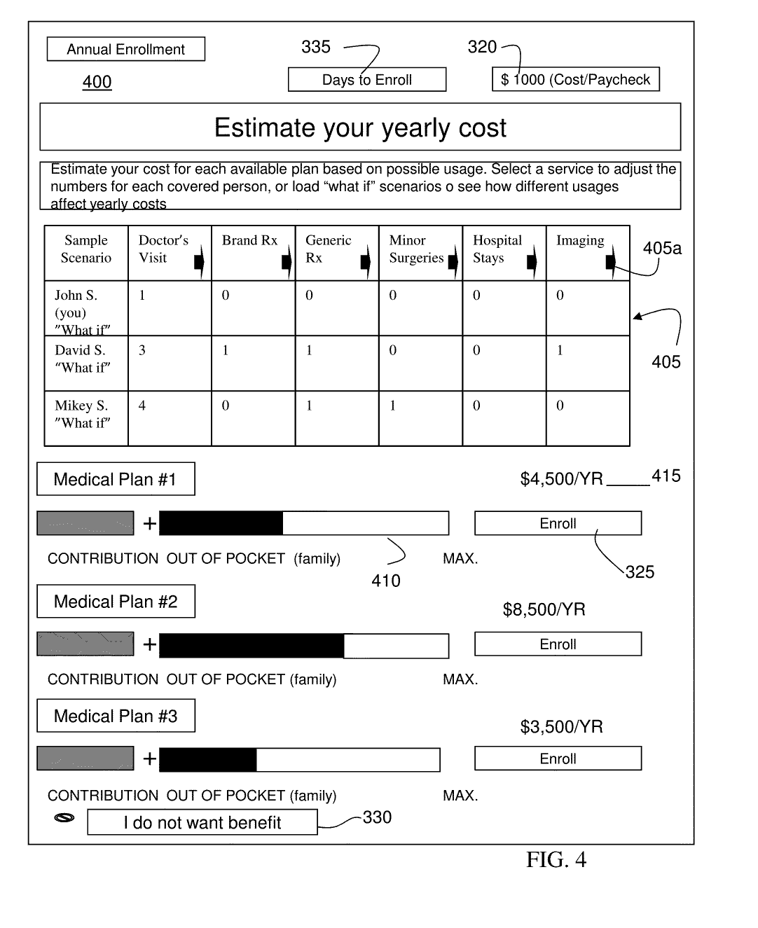

The cost comparison interface 300 can also be used as a launching site for the consumer to select different options and scenarios, which may be used in a cost calculation of particular medical plans, e.g., medical plan #1, medical plan #2 or medical plan #3. The launching can be effectuated by, for example, selecting any column, header or number, to open an editing screen. By way of example, by selecting medical plan #1, the user interface 400 of FIG. 4 can be displayed to the consumer.

In the user interface 400 of FIG. 4, the consumer (e.g., user) now has access to cost comparison tools, which may be used to estimate costs on a more granular basis. In embodiments, for example, the user interface 400 can include a table of sample scenarios (plan options) 405, for different plan participants to be covered by any of the offered medical plans. As shown in FIG. 4, these sample scenarios can include different plan participants to be covered by the medical plan, e.g., John S., David S. and Mikey S. (although any number of plan participants can be provided on this user interface 400), as well as a base value for a set of scenarios, which initially calculated using demographic information, e.g., age, gender, residence information, etc. for each covered person. For example, based on demographic information, the values of the different scenarios are automatically set.

In embodiments, the different scenarios shown in FIG. 4 include a set of base values for a typical usage scenario. These different scenarios include, by way of illustrative and non-limiting example, doctor's visits, brand Rx, generic Rx, minor surgeries, hospital stays, imaging, e.g., x-rays, etc. These base scenarios include a set of values, e.g., number, which is initially used to calculate the estimated costs for a typical usage plan, as shown at reference numeral 315 of FIG. 3 and reproduced at reference numeral 415 of FIG. 4.

Based on the typical usage scenario, several cost estimates can be provided to the consumer as shown at reference numerals 410 and 415. These cost estimates can be shown in a graphical format (e.g., bar graph 410) based on contributions and out-of-pocket expenses for the typical usage plan, as well as a total dollar amount shown at reference numeral 415. In embodiments, the graphical format 410 includes the maximum dollar amount that can be expended by the consumer, based on different scenarios and values. In addition, the graphical format 410 can include other information such as, for example, employer contributions (e.g., least amount paid as shown in FIG. 3) and any amount left or originally provided in the consumer's HSA account. Note that the total costs per year shown at reference numeral 415 for each medical plan will match the estimated typical yearly usage amount at reference numeral 315 of the cost estimator interface 300 of FIG. 3.

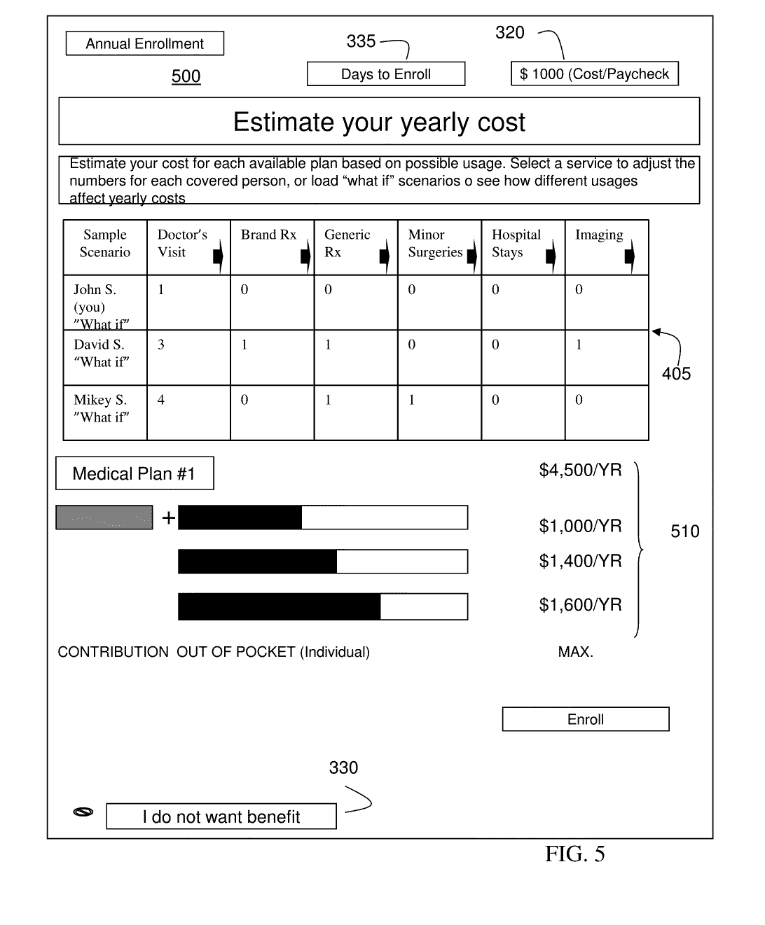

In embodiments, the contributions and out-of-pocket expenses shown in FIG. 4 are based on a plan having a maximum out-of-pocket expense for a family. It should be understood by those of ordinary skill in the art, though, that the maximum out-of-pocket expenses can be based on other factors such as out-of-pocket expenses for an individual as shown in FIG. 5 (or a combination of maximum out-of-pocket expenses for a family and an individual, depending on the selected medical plan). For example, in the illustration of FIG. 5, each plan participant is listed with associated graphical information and respective dollar amount (at reference numeral 510), which is representative of out-of-pocket expenses based on different scenarios and values. The costs for the different scenarios can be adjusted by the consumer as shown at reference numeral 405.

FIG. 4 further provides the consumer with the ability to enroll in a particular medical plan by selecting “button” 325. On the other hand, the user can deny coverage by simply selecting the “I do not want benefit” button 330. The interface 400 also shows the total amount of benefits per consumer's paycheck, as shown at reference numeral 320. In addition, the interface 400 provides additional information about the particular medical plans including, for example, the days left for enrollment 335.

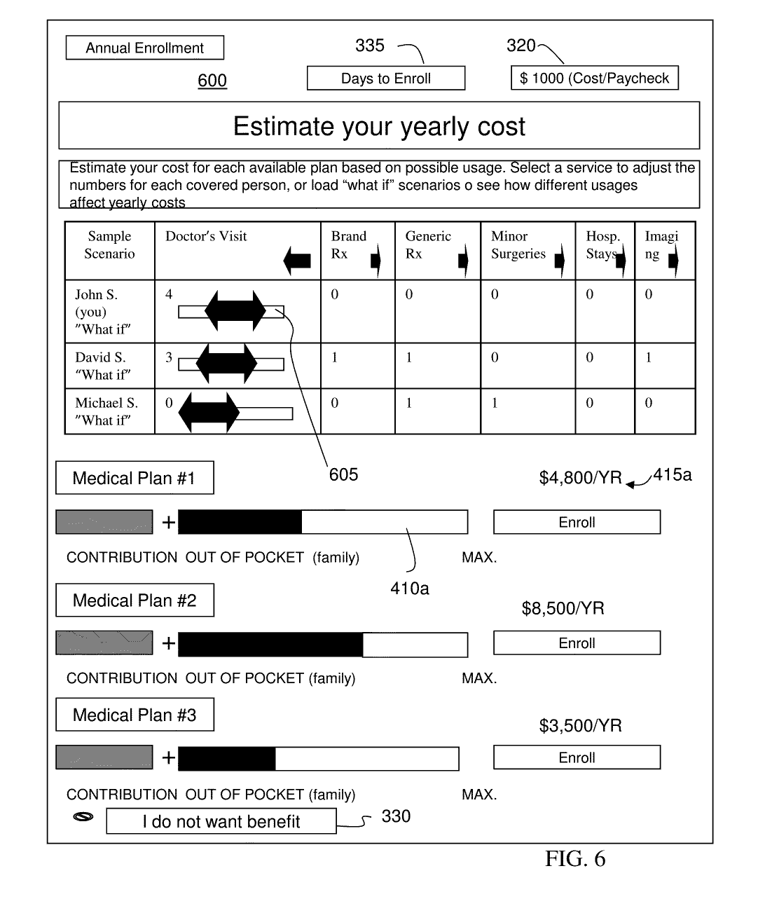

In any scenario, the interface 400 of FIG. 4 is further configured to allow the consumer to estimate the out-of-pocket expenses by adjusting the values of any scenario shown at reference numeral 405. That is, by selecting the arrow icon 405a or alternatively any of the scenarios at reference numeral 405, the cost estimator tool allows the consumer to adjust values of the scenarios, which will then be used to calculate an updated cost estimate, as shown for example in FIG. 6.

More specifically, in FIG. 6, the interface 600 is illustrative of the functionality permitting a consumer to adjust their cost contributions, e.g., out-of-pocket expenses. For example, FIG. 6 shows the consumer selecting the arrow associated with a doctor's visit 405a (although any of the different scenarios can be selected by the consumer) in order to make adjustments to the respective value. By selecting arrow 405a, the column associated with doctor's visit will expand, showing a slide bar 605. Advantageously, the slide bar 605 allows the consumer to have a clear, tactile way to edit the information and minimize the amount of clicks needed to set any value within this column. This interface will also encourage the consumer to adjust for different values and, in real time, see the results change in relation to their actions, e.g., moving the slider to the right will tend to increase the contribution dollar amount.

Accordingly, by using the slide bar 605, the consumer can adjust the number (value) of doctor's visit for any of the covered participants. It should be understood by those of ordinary skill in the art that this same process can be used for any other scenario shown in the table 405, and that alternative methods of adjusting the number of doctor's visit for each of the covered participants is contemplated by the present invention. For example, a fillable field may be provided by the interface, which allows the consumer to enter a number (value) within the fillable field.

In any of these alternative methods, the adjustment of the number of doctor's visits (or any other scenario in table 405) will automatically result in a recalculation of the out-of pocket expenses for each medical plan, as shown at reference numerals 410a and 415a. That is, the bar graph shown at reference numeral 410a will update (compared to the graph shown at reference numeral 410 of FIG. 4), in addition to the total contribution per year amount as shown at reference numeral 415a (compared to the total contribution per year shown at reference numeral 415 of FIG. 4). The dollar amount at reference numeral 415a will be automatically update as the typical yearly usage amount at reference numeral 315 of the cost estimator interface 300 of FIG. 3.

In embodiments, the recalculation can be based on the particular costs associated with the medical plan. By way of example, if the consumer selected two additional doctor's visits per year, and the medical plan includes an out-of-pocket expense (e.g., copayment) of $50 for each additional doctor's visit, the total contribution per year amount as shown at reference numeral 415a will be updated by $100 (e.g., 2×$50/visit=$100). Similar calculations can be performed for different scenarios. For example, a minor surgery may result in an additional cost of $100 per surgery, resulting in the total contribution per year amount increasing by $100. In embodiments, this calculation is based on each particular medical plan costs, deductibles, and other cost factors associated with the particular medical plan.

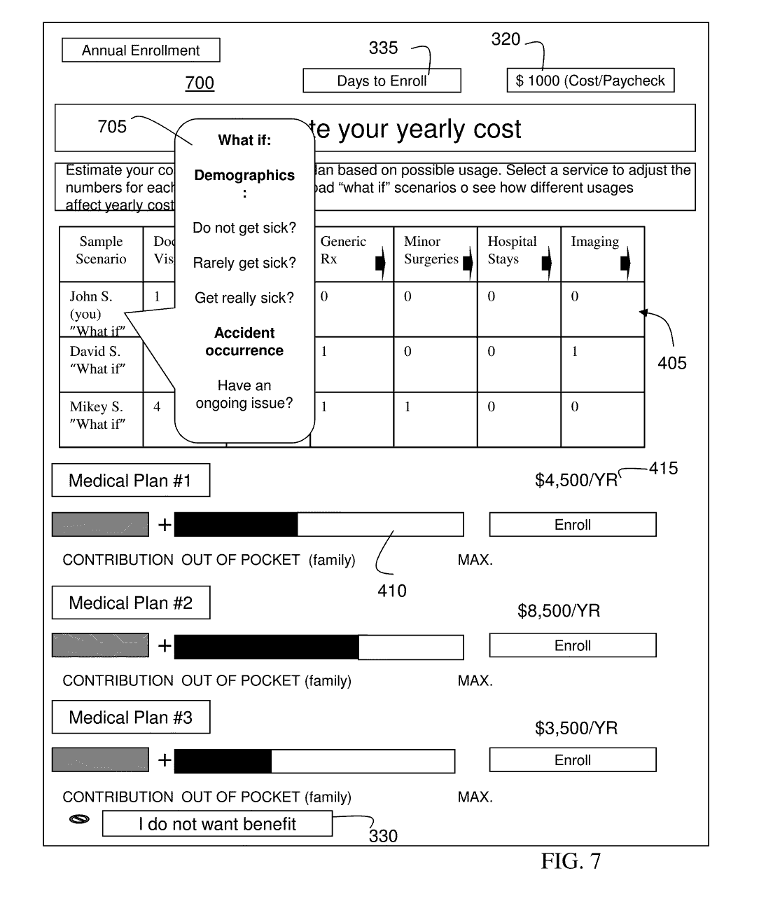

FIG. 7 is representative of an additional feature of the present invention. More specifically, the interface 700 of FIG. 7 shows the selection of a “what if” scenario 705. In embodiments, the “what if” scenario 705 provides the consumer with the ability to select certain predefined values for different scenarios, without the need to select individual scenarios and values in table 405 for each plan participant. That is, the “what if” scenario 705 allows the user to check out sample use groupings, with multiple selections accumulating. By way of example, based on demographic information, the “what if” scenario 705 provides the consumer with the ability to select multiple different categories which will pre-populate the different scenarios 405 with predefined values, thereby reducing any possible “guess” work of the consumer.

In the example shown in FIG. 7, the different scenarios are based on generic demographic terms, e.g., “do not get sick”, “rarely get sick” and “get really sick”. Of course other terms are contemplated by the present invention. By selecting the particular scenario, e.g., “do not get sick”, the value in each of the different scenarios will populate accordingly, resulting in a recalculation of the out-of-pocket expenses shown in graphical format at reference numeral 410 and dollar amount shown at reference numeral 415, for each medical plan. The dollar amount at reference numeral 415 will be automatically updated as the typical yearly usage amount at reference numeral 315 of the cost estimator interface 300 of FIG. 3.

Advantageously, the “what if” scenario 705 allows the consumer to have a clear, tactile way to edit the information and minimize the amount of clicks needed to set the value. This interface will also encourage the consumer to select different scenarios, and automatically see a change in the values for different categories. Additionally, in real time, the consumer can see the change in relation to their actions, as already described herein.

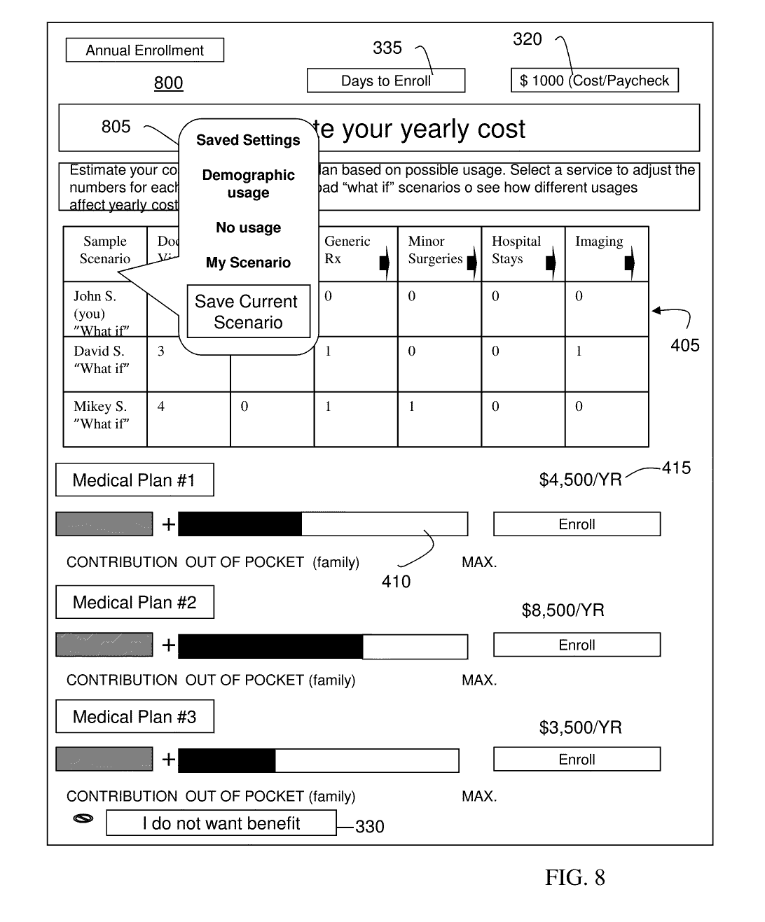

FIG. 8 shows a user interface 800, which provides the consumer the ability to select saved scenarios, as well as save a current scenario. This functionality can be provided by a drop down menu or bubble box shown at reference numeral 805. In embodiments, giving the consumer control over what is saved rather than saving it by default gives them the ability to create multiple custom scenarios, encouraging exploration amongst other advantages. Regardless of the decision on this display, values entered on the cost estimator tool should be retained for at least the current session.

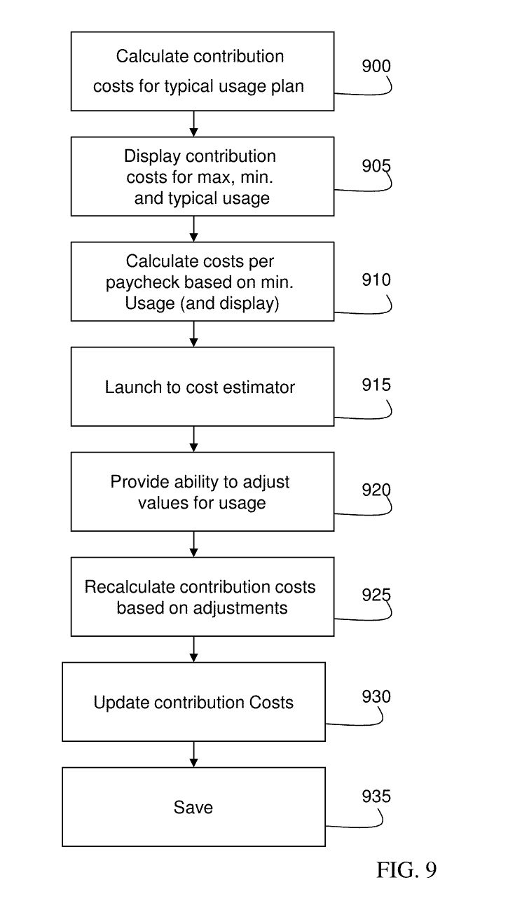

FIG. 9 depicts an exemplary flow for a process in accordance with aspects of the present invention. The exemplary flow can be illustrative of a system, a method, and/or a computer program product and related functionality implemented on the computing system of FIG. 1, in accordance with aspects of the present invention. The computer program product may include computer readable program instructions stored on computer readable storage medium (or media). The computer readable storage medium include the one or more storage medium as described with regard to FIG. 1, e.g., non-transitory media, a tangible device, etc. The method, and/or computer program product implementing the flow of FIG. 4 can be downloaded to respective computing/processing devices, e.g., computing system of FIG. 1 as already described herein, or implemented on a cloud infrastructure as described with regard to FIG. 2. Accordingly, the processes associated with each flow of the present invention can be implemented by special purpose hardware-based systems that perform the specified functions or acts or carry out combinations of special purpose hardware and computer instructions.

Referring to FIG. 9, at step 900, the processes of the present invention, e.g., cost estimator tool, will calculate a contribution cost for a typical usage plan using demographic information. In embodiments, the demographic information can be provided by actuary tables obtained from, e.g., Bureau of Labor Statistics, U.S. Department of Health and Human Services, etc. Based on these actuary tables, which may include health of participants (i) within certain age groups and gender, (ii) residing at certain locations, and (iii) within certain income brackets, etc, it is possible to calculate expected annual cost for each consumer to be enrolled in a medical insurance plan, using, e.g., risk-adjustment models, predictive modeling, etc.

In embodiments, this calculation can include a maximum contribution cost and a minimum contribution cost for the consumer, based on the parameters of an individual medical plan. For example, the processes of the present invention can obtain associated costs for each medical plan, including out-of-pocket expenses from the medical insurer, employer, etc., based on many different factors including premium contributions from the employer, HSA accounts of the participant, etc. Once all of this information is obtained and collated, the processes of the present invention can provide a calculated contribution cost, including a maximum cost and a minimum cost for out-of-pocket expenses, e.g., total contribution costs for a plan participant.

At step 905, the processes of the present invention can display this information to the consumer. In embodiments, this information can be displayed in a user interface, as described herein. For example, the present invention contemplates displaying maximum and minimum contribution costs, as well as typical contribution costs. In embodiments, the minimum contribution cost can be further provided as a per paycheck cost to the consumer at step 910.

At step 915, the processes of the present invention can launch the consumer to a cost estimator interface, which allows the consumer to adjust certain values based on certain scenarios. In embodiments, the consumer can select a particular medical plan or icon on an initial user interface to launch to the cost estimator interface.

At step 920, the processes of the present invention and more particularly the cost estimator interface provides the consumer with the ability to adjust values associated with different scenarios, as already described herein. For example, the consumer can adjust a number of visits to a doctor's office, different combinations of prescriptions, etc. (plan options). In embodiments, the values can be adjusted by a slide bar, a manual entry in a fillable field, or by group settings.

Based on the new values, and the information obtained and/or known from step 900, the processes of the present invention will recalculate the total contribution costs for the consumer at step 925. This updated contribution cost can then be automatically updated for each medical plan, which can be automatically updated in any combination of user interfaces shown in FIGS. 3-8 as provided at step 930. At step 935, the consumer can save the cost estimate for future review and adjustments.

The service provider or other third party vendor can provide the services of the present invention based on, for example, a subscription business model. To this end, the service provider and/or third party vendor can create, maintain, support, etc., a computer infrastructure, such as computing system 100 (FIG. 1) that is configured to provide a service such as a cost estimation for different medical plans to a consumer. In return, the service provider can receive payment from the client(s) under a subscription agreement such as a subscription price paid to have access to the computer infrastructure and/or service.

The foregoing examples have been provided merely for the purpose of explanation and are in no way to be construed as limiting of the present invention. While aspects of the present invention have been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although aspects of the present invention have been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A method of modeling medical insurance expenses implemented by a computer system, comprising:
determining an initial estimate of a contribution cost to a consumer for a plurality of offered medical insurance plans based on demographic information associated with the consumer;
launching the consumer to an estimator tool which displays values associated with different scenarios initially based on the demographic information;
recalculating the initial estimate of the contribution cost of the plurality of offered medical insurance plans based on adjusted values of one or more of the different scenarios, as adjusted by the consumer; and
displaying, as an updated estimate contribution cost, the recalculated initial estimate of the contribution cost to the consumer for each of the offered medical insurance plans.

2. The method of claim 1, wherein the initial estimate of the contribution cost is provided on a launching site, which is automatically updated with the updated estimate contribution cost.

3. The method of claim 1, wherein the adjusted values are a numeric value associated with a cost for plan options for each of the plurality of offered medical insurance plans.

4. The method of claim 3, wherein the numeric value is associated with at least one of a medical service and a prescription type.

5. The method of claim 1, wherein the recalculated initial estimate of the contribution cost includes a consumer contribution and an out-of-pocket expense for plan options for each of the plurality of offered medical insurance plans.

6. The method of claim 1, wherein the initial estimate of the contribution cost of the plurality of offered medical insurance plans includes a calculated maximum cost, a minimum cost and a typical usage cost.

7. The method of claim 6, wherein:
the minimum cost and the maximum cost are static contribution costs of the consumer which do not change after the recalculating of the initial estimate of the contribution cost; and
the typical usage cost is updated with the updated estimate contribution cost after the recalculating of the initial estimate of the contribution cost.

8. The method of claim 6, further comprising calculating a per pay check cost to the consumer, based on the minimum cost.

9. The method of claim 1, wherein:
the updated estimate contribution cost is provided in a graphic format with a delineation of contribution cost and out-of-pocket expenses for each of the plurality of offered medical insurance plans; and
the out-of-pocket expenses are provided based on criteria for each of the plurality of offered medical insurance plans.

10. The method of claim 1, wherein the adjusted values are provided by one of a slide bar, a fillable field and a group setting.

11. The method of claim 10, wherein the group setting is one of a predetermined what if scenario.

12. The method of claim 1, wherein the modeling medical insurance is provided by a service provider under a subscription agreement.

13. A computer system for generating estimate contribution costs for medical insurance, comprising:
a hardware memory device that stores program instructions and demographic and associated cost information associated with a plurality of medical insurance plans; and
a processor that executes the program instructions and causes the computer system to:
estimate a minimum contribution cost, typical contribution cost and maximum contribution cost for a plurality of offered medical insurance plans based on the demographic information associated with the consumer;
recalculate the typical contribution cost of the plurality of offered medical insurance plans based on adjusted values of one or more of different plan options for each of the plurality of offered medical insurance plans; and
automatically display, as an updated estimate contribution cost, the typical contribution cost to the consumer for each of the offered medical insurance plans.

14. The computer system of claim 13, wherein the adjusted values are a numeric value associated with a cost for the different plan options for each of the plurality of offered medical insurance plans.

15. The computer system of claim 13, wherein the estimate of the minimum contribution cost is initially displayed and then automatically updated and displayed with the updated estimate contribution cost, after the recalculating.

16. The computer system of claim 13, wherein:
the minimum contribution cost and the maximum contribution cost are static estimates which do not change after the recalculating; and
the typical contribution cost is updated with the updated estimate contribution cost after the recalculating.

17. The computer system of claim 13, wherein:
the updated estimate contribution cost is provided in a graphic format for each plan participant or combination thereof, with a delineation of contribution cost and out-of-pocket expenses for each of the plurality of offered medical insurance plans; and
the out-of-pocket expenses are provided based on criteria associated with each of the plurality of offered medical insurance plans.

18. The computer system of claim 13, wherein the adjusted values are provided by one of a slide bar, a fillable field and what if scenarios.

19. The computer system of claim 13, wherein a service provider at least one of creates, maintains, and supports the computer system.

20. A computer program product comprising computer readable program instructions stored on non-transitory computer readable storage medium, the computer readable program instructions causing a computing device to:
estimate a minimum contribution cost, typical contribution cost and maximum contribution cost for a plurality of offered medical insurance plans based on the demographic information associated with the consumer;
display the minimum contribution cost, typical contribution cost and maximum contribution cost for the plurality of offered medical insurance plans;
calculate and display a per pay check cost for the minimum contribution cost for the plurality of offered medical insurance plans;
recalculate the typical contribution cost of the plurality of offered medical insurance plans based on adjusted values of one or more of different plan options for each of the plurality of offered medical insurance plans; and
automatically updated the typical contribution cost, while keeping the minimum contribution cost and the maximum contribution cost static.
